(19) United States
(12) Patent Application Publication
(10) Pub. No.: US 2005/0119946 A1
(43) Pub. Date: Jun. 2, 2005

(54) Method and device for comparing the properties of products

(76) Inventor: Sabahattin Cakiral, Darmstadt (DE)

Correspondence Address: SQUIRE, SANDERS & DEMPSEY L.L.P, 600 HANSEN WAY, PALO ALTO, CA, 94304-1043, US

(21) Appl. No.: 10/509,045

(22) PCT Filed: Mar. 26, 2003
(86) PCT No.: PCT/EP03/03155

(30) Foreign Application Priority Data
Mar. 26, 2002 (DE) 102 13 735.8

(51) Int. Cl. G06F 17/60

(52) U.S. Cl. 705/27

(57) ABSTRACT

A device and a method are disclosed for checking properties of wares and services. Standardized properties of wares and services are stored in a first database, wherein the wares and services are provided with a unique product identification code. Exclusion and desired criteria for wares and services for at least one user each are stored in a second database, access to the criteria being given by a unique user identification. With aid of a device which determines the product identification code, the product properties are preferably retrieved on-line and compared with the criteria of the user. The comparison can be done on-line on a central server or on a hand-reading device which the user carries with him. The user is advised optically or acoustically of the result.

The invention relates to methods and devices for checking properties of wares and services. In particular, these are systems which enable the user to check the quality features and ingredients of products.

In the course of the ever increasing spread of allergies, consumers have the need to quickly and easily analyze what the consumer products contain. However, this is not always readily possible since only a small part and only the necessary substances are often shown on the packaging. Even if the ingredients are noted on the packaging, the consumer requires longer time to determine which ones are of concern to him.

The object of the invention is to provide a method and a device which enable the consumer to determine in best time whether the product meets his requirements.

This object is solved by the inventions according to the features of the independent claims. Advantageous embodiments of the inventions are described in the subclaims. An important feature is a mobile terminal which can access exclusion and desired criteria by means of user identification, whereby the terminal has input capabilities, in particular a bar code reader, with reference to which the product properties can be determined by a central database. The two informations can be compared either on the user device or on a central server. A further embodiment is provided for the Internet in which a simple interlinking and loading of information is used to obtain the desired result. Details are described below.

In particular, the present method for checking properties of wares and services comprises access to a first database in which standardized properties of wares and services are stored. To enable access to these properties, the wares are provided with a unique product identification which is preferably a bar code. Other machine-readable identifications are also feasible. If the invention is to be applied via the Internet, then a unique link (URL) is the preferred variant. Preferably, the structuring of the information is group oriented, so that access to the information is quickly possible. The properties are input by the manufacturer or by the firm which distributes the products. Preferably, they are stored in XML. To ensure that there are no allocation difficulties, a number of ingredients are provided from which a subset is selected. This approach requires that the database system be continuously adapted and updated by new classes and particulars.

The method has a reading capability on a further database in which exclusion and desired criteria for wares and services can be accessed by means of a unique user identification. These criteria correspond to the criteria for the wares and services, as already described above. Here, the user can individually indicate by links which criteria he prefers or which ones he would like to avoid. It is pointed out that this is only one possible embodiment. In other embodiments, fuzzy terms and synonym lists can be used from which the information can be derived. It is also feasible to use interference algorithms which solve the problem posed. The noted criteria are maintained for groups or specific products or services by the user or templates can be provided which the user specially adapts. Thus, it is feasible that templates are provided for house dust allergies or other allergies which the user only has to incorporate in his individual profile. This profile is accessed by a unique user identification. The databases are accessed after the user has marked a product or a service, preferably interactively, as a result of which the product identification is determined. This identification is used in a further step in which the user provides its unique user identification to determine exclusion and desired criteria as well as the properties of the wares and services on the basis of the product identification. In a further step, in which the criteria are compared with the properties, the user is advised of the result.

In a further embodiment, the user profiles are not stored on a central server, but locally on a mobile device. In this embodiment, Internet access to a local server is not required. The mobile terminal is preferably connected via a wireless LAN or another network with a database in which the properties of wares and services are stored. The comparison step takes place either in the mobile device after transmission of the product properties or in a central or decentralized device which is situated in the network by providing the central or decentralized device with the exclusion and/or desired criteria. To record the product identification, the mobile device may have an optical reading device with which a bar code can be read.

If, on the other hand, a virtual unreal product is checked which is offered in the Internet, whereby the product identification is preferably configured as a unique link in the Internet, then access to the first database with the product identification is made possible by clicking. It is possible to generate cost information based on the corresponding signature of this link. The vendor has to provide this in the following. The user identification is preferably provided by information stored on the client (computer or mobile terminal). However, it is also possible that a special window is opened in which the user can enter his code. The preferred variant is, however, a cookie which codes the user information. In this solution, the comparison operation can take place on a central server. However, it is also feasible that the required information is transmitted to the client who carries out the comparison operations.

A further component of the present invention is a mobile user device for checking properties of wares and services which is preferably embedded in an infrastructure as described in the preceding methods. A product identification is read in or input via a reading or input unit. A user identification or the exclusion and desired criteria are stored in a storage area. The user identification and the product identification are sent to a central server via network access means. Via the identifications, the server has access to the properties of wares and services which he then compares with the exclusion and inclusion criteria. The latter are associated with the user identification. The result of the comparison is sent back and the result of the comparison is shown in a display unit, in particular the degree of agreement and/or deviation.

In a modified embodiment, the comparison is carried out on the mobile terminal, whereby either the exclusion and desired criteria are stored on the device or loaded via the network. On the other hand, the product properties are loaded by the network.

Inputting is preferably performed via a bar code reader or a keyboard. Pens which enable a handwriting identification are also feasible. The connection to a network preferably takes place by means of a wireless LAN, a GSM network or UMTS network.

A further component of the present invention is a software which implements the functionality on a conventional PDA. Reference is made to the claim for details. A further part of the invention is a data carrier which incorporates this software.

Another component of the invention is a server system which consists of several interlinked or a single server and which takes over the data management, in particular for the products and the user, and enables comparison operations.

The invention will be described in greater detail in the following with reference to examples of embodiments which are schematically illustrated in the drawings. Same reference numbers designate the same elements in the individual figures, which show in detail:

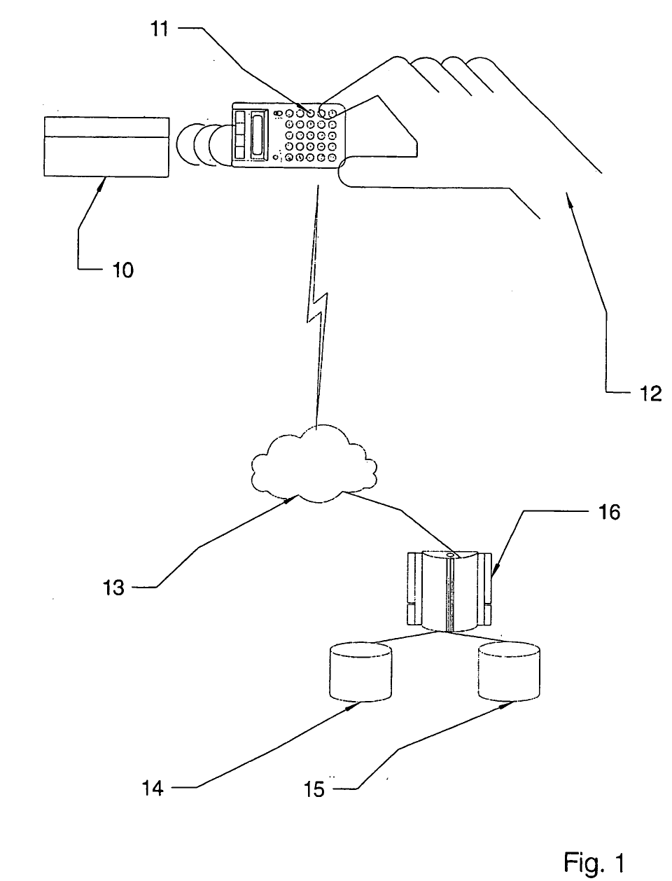

FIG. 1 a mobile terminal according to the invention which reads the information via a scanner in order to then transmit it over a wireless network and a further network to a central computer which has access to various databases in which the required information is stored;

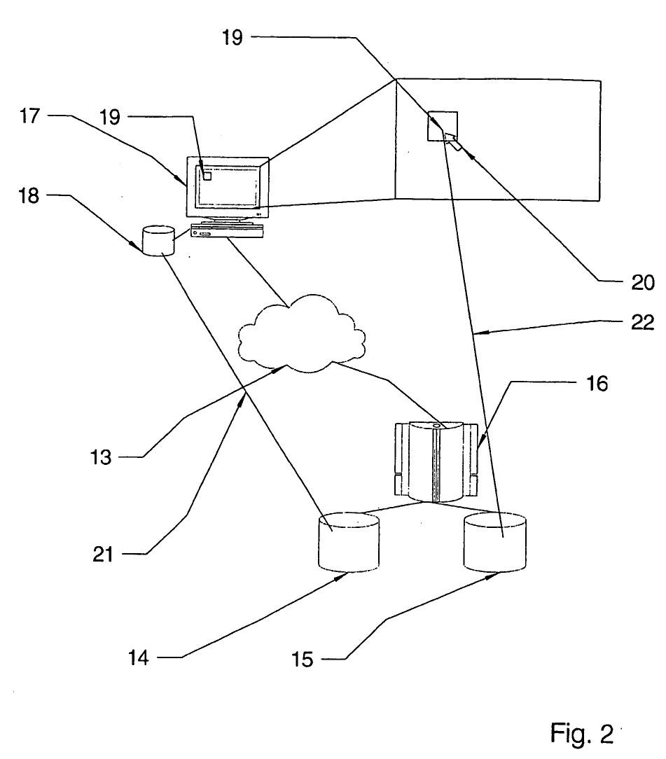

FIG. 2 a device within the Internet according to the invention in which the corresponding databases are referenced by way of an area which is configured as a link and in which a cookie is stored on the user's computer.

Numerous variations and further developments of the described embodiments can be realized within the scope of the invention.

The preferred two embodiments are described in FIGS. 1 and 2.

FIG. 1 shows a mobile device 11, as it can e.g. also be configured in the form of a pen, with which a user 12 can check the ingredients of products 10, e.g. when shopping. The user identification is stored on the device 11, wherein in special cases also the profile, i.e. the exclusion and desired criteria, are stored. In this case, the latter are used for comparison on the terminal.

If, on the other hand, only the identifications are present, then both are transmitted to a central server 16 which has access to the databases 14 and 15. The properties of wares and services and the exclusion and desired criteria can be determined on these databases with reference to the identification. After the two pieces of information have been determined, they are compared and the result is transmitted via the network 13 and the radio link to the terminal 11.

FIG. 2 shows an alternative embodiment in which the user is connected to the central server 16 via a client computer 17 and the Internet. A link area 19, which is shown in an enlargement of the screen, can be clicked on by a mouse 20, said clicking on causing a unique product identification to be sent to the server 16. In this way, the link area 19 represents a reference 22 to the information in the database 15. The reference 21 makes the connection of the user identification which is stored in a storage medium of the client computer 17 with the information in the database 14. The comparison operations can take place both on the client computer and on the server.

1-16. (canceled)

17. A method of checking properties of wares or services, the method comprising:
providing a first database in which the properties of wares or services are stored, the wares or services being identifed by a unique product identification code;
providing a second database in which user profiles containing exclusion or desired criteria for the wares or services for each respective user are stored;
a particular user selecting a ware or service and determining the product identification code therefor;
retrieving the properties of the wares or services on the basis of the determined product identification code;
retrieving the exclusion or desired criteria for the particular user;
comparing the retrieved exclusion or desired criteria for the wares or services with the retrieved properties of wares or services; and
advising the particular user of the result of the comparison.

18. The method of claim 17, wherein the exclusion and desired criteria and said properties are stored in a structured manner, and wherein properties and said exclusion and desired criteria are retrieved by carrying out a hierarchical search.

19. The method of claim 17, wherein a user profile containing said exclusion and desired criteria are stored in a mobile device and the comparison takes place in the mobile device upon receipt of the properties of the wares or services from a central server, or wherein said user profile is transmitted to said central or decentralized server and said comparison takes place in said central server.

20. The method of claim 17, further comprising inputting the properties of the wares or services and user profiles containing exclusion or desired criteria in a configuration step.

21. The method of claim 17, wherein the product identification code is a bar code.

22. The method of claim 17, wherein the product identification code is configured as a unique link on the Internet which is adapted, when activated, to access the first database, wherein the particular user enables access to the exclusion or desired criteria, and wherein the comparison operation takes place on a central server.

23. The method of claim 22, wherein access to the exclusion or desired criteria is enabled by a cookie stored on a device associated with the particular user.

24. The method of claim 17, wherein the product identification code is stored as unique information on the Internet, wherein a client computer reads the product identification code and retrieves the properties of the wares and services from the first database over the Internet, the client computer retrieves the exclusion or desired criteria from said second database, which is either at a central server or in a local database on the client computer, and effects said comparison.

25. The method of claim 17, wherein said exclusion or desired criteria are associated in said second database with a unique identification code for each user, and said exclusion or desired criteria are retrieved from said second database on the basis of said unique user identification code.

26. A mobile user device for checking properties of wares or services, comprising:
an input unit by means of which properties of wares or services can be input;
a storage area in which a user identification code is stored;
network connection means adapted to send the user identification code and a unique identification code for the wares or services to a central server, the central server being adapted to access the properties of the wares or services by means of the unique product identification code and compare them with exclusion or desired criteria associated with the unique user identification code in order to send the result of the comparison back to the mobile user device; and
a display unit for showing the result of the comparison of the properties of the wares or services with the exclusion or desired criteria.

27. The mobile user device of claim 26, wherein said input unit is a code reader.

28. A mobile user device for checking properties of wares or services, comprising:
an input unit by means of which properties of wares and services can be input;
a storage area in which a user profile containing exclusion or desired criteria is stored;
a network connection means adapted to send a unique product identification code for the wares or services to a central server, the central server being adapted to access the properties of wares or services via said unique product identification code, and receive the properties of wares or services back from the central server;
a comparison unit for comparing the properties of the wares or services with the exclusion or desired criteria stored in said storage area; and
a display unit adapted to show the display of said comparison.

29. The mobile user device of claim 28, wherein said input unit is a code reader.

30. The mobile user device of claim 29, wherein said code reader is a bar code reader.

31. The mobile user device of claims 26 or 28, comprising means which enable a connection to a wireless LAN, a GSM network or UMTS network.

32. A software module for a mobile user device which when run on said mobile user device:
provides an input capability for an identification code associated with properties of wares or services;
reserves a storage area in which a user profile containing exclusion or desired criteria for a particular user is stored;
allows a unique product identification code to be sent to a central server which has access to the properties of the wares or services associated with the unique product identification code;
receives the properties of the wares or services from the central server and compares them with the exclusion or desired criteria; and
displays the result of the comparison on said mobile device.

33. A software module for a mobile user device which when run on said mobile user device:
provides an input capability for an identification code associated with properties of wares or services;
reserves a storage area in which a user profile containing a unique user identification code is stored;
allows the unique user identification code and a unique product identification code to be sent to a central server which has access to the properties of the wares or services associated with the unique product identification code and performs a comparison of the properties of said wares or services associated with said unique product code with the exclusion or desired criteria associated with said unique user identification code;
receives the result of said comparison performed at the central server; and
displays the result of said comparison on said mobile device.

34. The software module of claim 32 or 33, wherein the mobile user device is a personal digital assistant (PDA) or a mobile telephone.

35. A data carrier, comprising a loadable data structure which stores the software module of claim 32 or 33.

36. A server system comprising several interlinked servers or a single server, the server system comprising:
a first storage medium on which a first database is stored in which properties of wares or services are stored, wherein the wares or services are associated with a unique product identification code;
a second storage medium on which a second database is stored in which exclusion or desired criteria for wares or services for each respective user are stored, wherein access to the criteria is given on the basis of a unique user identification code associated with each user;
a network unit which receives the user identification code and the product identification code; and
a processing unit which is capable of downloading the exclusion or desired criteria and the properties of the wares or services from the first and second databases on the basis of the product identification code and the user identification code in order to then compare them and transmit the result or store the result for later recall.

37. The server system of claim 35, further comprising means for receiving a URL query, whereby the product identification code can be found in the URL query, means for requesting a unique user identification code from a client.

38. The server system of claim 35, wherein the user identification code is provided in form of a cookie.

39. A data carrier comprising a computer-loadable data structure which implements the functionality of the server as defined in claim 35 on a conventional computer.
